(19) United States
(12) Patent Application Publication
(10) Pub. No.: US 2015/0066245 A1
(43) Pub. Date: Mar. 5, 2015

(54) VEHICLE CONTROLLING APPARATUS INSTALLED ON STEERING WHEEL

(71) Applicant: Hyundai Motor Company, Seoul (KR)

(72) Inventors: Hui Sung LEE, Gunpo-si (KR); Sung Min PARK, Seoul (KR); Sung Jin SAH, Suwon-si (KR); Kwang Myung OH, Daejeon (KR)

(73) Assignee: HYUNDAI MOTOR COMPANY, Seoul (KR)

(21) Appl. No.: 14/095,535

(22) Filed: Dec. 3, 2013

(30) Foreign Application Priority Data
Sep. 2, 2013 (KR) 10-2013-0104738

(51) Int. Cl. G05D 1/00; B60W 50/10; G06F 3/16

(52) U.S. Cl. CPC G05D 1/0016; G06F 3/16; B60W 50/10; B60W 2540/02
USPC 701/2

(57) ABSTRACT

A vehicle controlling apparatus installed on a steering wheel includes an acoustic wave sensor disposed on the steering wheel of a vehicle, the sensor converting an acoustic wave signal generated by an input from the outside into an electrical signal. A controller is configured to analyze the electrical signal received from the acoustic wave sensor to recognize a pattern depending on the input from the outside and perform an operation depending on the recognized pattern.

### CROSS-REFERENCE TO RELATED APPLICATION

This application is based on and claims the benefit of priority to Korean Patent Application No. 10-2013-0104738, filed on Sep. 2, 2013 in the Korean Intellectual Property Office, the disclosure of which is incorporated herein in its entirety by reference.

### TECHNICAL FIELD

The present disclosure relates to a vehicle controlling apparatus installed on a steering wheel, and more particularly, to a vehicle controlling apparatus installed on a steering wheel capable of being easily operated by a driver and controlling various apparatuses in a state in which the driver keeps his hands on the steering wheel without dispersing a line of sight of the driver, by applying an acoustic wave sensor or a touch pad to the steering wheel of the vehicle.

### BACKGROUND

Drivers steer a steering wheel of a vehicle to drive the vehicle. The steering wheel of the vehicle as described above may be recently mounted with an integrated remote controller or a multi-switch so as to be easily operated. Recently, a scheme of variously utilizing the steering wheel of the vehicle has been provided. For example, the steering wheel has been mounted with a heat wire to assist in driving in winter.

Interests of consumers in interior items and convenience items of the vehicle as well as the appearance of the vehicle have increased. Thus, a technology capable of simply operating and controlling electronic apparatuses previously mounted in the vehicle using the steering wheel of the vehicle have increased to be generalized and gentrified. In addition, a technology of simply operating and controlling electronic apparatuses that may be additionally mounted in the vehicle using the steering wheel of the vehicle has developed.

However, a vehicle steering wheel remote controller apparatus according to the related art has a limitation in performing a function of an electronic apparatus since the number of physical buttons that may be implemented is limited, and each button carries out only one function. For example, in the case of operating an audio mode using the steering wheel remote controller apparatus, several functions such as a volume control function, a replay function, a forward wind function, a rewind function, and the like, are allocated to different buttons, which a driver manually operates. In addition, in the case in which the steering wheel remote controller apparatus is implemented by a touch pad, a tactile feedback depending on an input to perform a function of the electronic apparatus is not present, such that the driver should directly confirm a feedback depending on the input.

Therefore, the driver's attention is distracted at the time of driving the vehicle by operating above-mentioned functions of the electronic apparatus according to the related art, such that an unexpected accident is generated. There is a size limitation in buttons or a touch pad on the steering wheel, such that it is difficult to manufacture the steering wheel in various forms.

### SUMMARY

The present disclosure has been made to solve the above-mentioned problems occurring in the prior art while advantages achieved by the prior art are maintained intact.

An aspect of the present disclosure provides a vehicle controlling apparatus installed on a steering wheel capable of being easily operated by a driver and controlling various apparatuses in a state in which the driver keeps his hands on the steering wheel without being distracted along a line of sight, by applying an acoustic wave sensor or a touch pad to the steering wheel of the vehicle.

Another aspect of the present disclosure provides a vehicle controlling apparatus installed on a steering wheel capable of minimizing a space limitation of the steering wheel at the time of manufacturing the steering wheel as compared with a button or switch scheme according to the related art, by applying an acoustic wave sensor or a touch pad to the steering wheel of the vehicle.

Another aspect of the present disclosure provides a vehicle controlling apparatus installed on a steering wheel having an improved abrasion resistance and durability, by applying an acoustic wave sensor or a touch pad to the steering wheel of the vehicle to minimize a mechanical operation as compared with a button or switch scheme according to the related art.

According to an exemplary embodiment of the present disclosure, a vehicle controlling apparatus installed on a steering wheel includes an acoustic wave sensor disposed on the steering wheel of a vehicle, the sensor converting an acoustic wave signal generated by an input from outside the sensor into an electrical signal. A controller is configured to analyze the electrical signal received from the acoustic wave sensor to recognize a pattern depending on the input from the outside and perform an operation depending on the recognized pattern.

The acoustic wave sensor may be mounted on any one of front and rear surfaces of the steering wheel.

The controller may recognize the pattern from the electrical signal converted from a dragging signal, which is the acoustic wave signal generated by a horizontal or vertical input and a tapping signal, which is the acoustic wave signal generated by tapping.

The vehicle controlling apparatus installed on a steering wheel may further include a touch pad connected to the acoustic wave sensor to generate a vibration signal by the input from the outside.

The touch pad mounted on a front surface of the steering wheel may include at least two touch pads having different tactile feelings.

The touch pad may include a dragging pad mounted on a front surface of the steering wheel and a tapping pad is mounted on a rear surface of the steering wheel.

The controller may recognize the pattern from a horizontal or vertical drag signal input to the dragging pad and a tapping signal input to the tapping pad.

The controller may control cluster information of the vehicle, an AVN (Audio, Video, and Navigation) screen, vehicle internal lighting, a wiper, cooling and heating, a sunroof, an audio device, an air conditioner, and various convenience devices based on the recognized pattern.

### BRIEF DESCRIPTION OF THE DRAWINGS

The above and other objects, features, and advantages of the present disclosure will be more apparent from the following detailed description taken in conjunction with the accompanying drawings.

FIG. 1 is a block diagram showing main components of a vehicle controlling apparatus installed on a steering wheel according to an exemplary embodiment of the present disclosure.

FIG. 2 is a diagram showing a steering wheel mounted with an acoustic wave sensor according to an exemplary embodiment of the present disclosure.

FIGS. 3A to 4B are diagrams showing a method of using a touch pad mounted on a steering wheel according to an exemplary embodiment of the present disclosure.

FIGS. 5A to 6G are diagrams for describing a controlling method using a touch pad mounted on a steering wheel according to an exemplary embodiment of the present disclosure.

FIG. 7 is a block diagram showing main components of a vehicle controlling apparatus installed on a steering wheel according to another exemplary embodiment of the present disclosure.

FIG. 8 is a diagram showing a steering wheel mounted with a touch pad according to another exemplary embodiment of the present disclosure.

### DETAILED DESCRIPTION

Hereinafter, exemplary embodiments of the present disclosure will be described in more detail with reference to the accompanying drawings. In describing the exemplary embodiments of the present disclosure, a description of technical contents that are well-known in the art to which the present disclosure pertains and are not directly related to the present disclosure will be omitted. An unnecessary description is omitted to make the gist of the present disclosure clear.

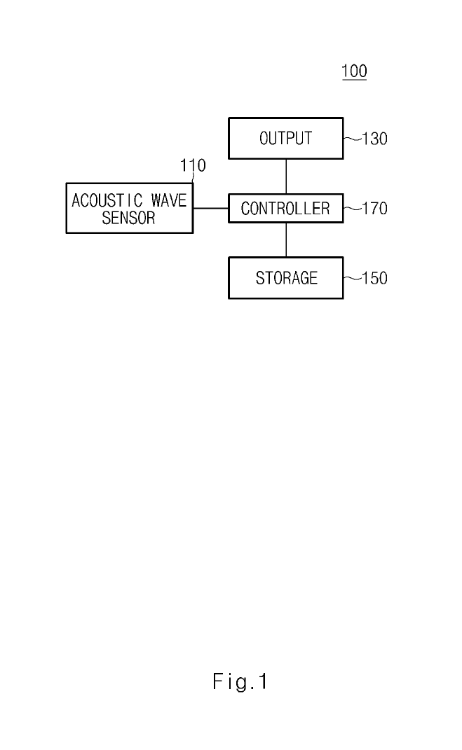

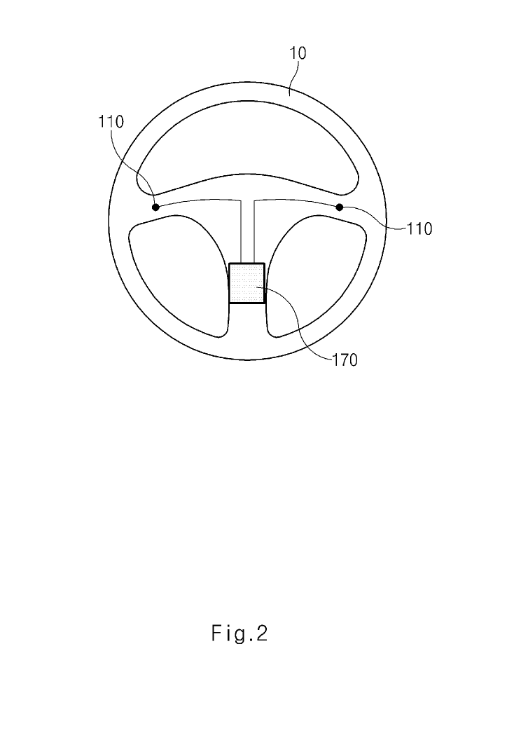

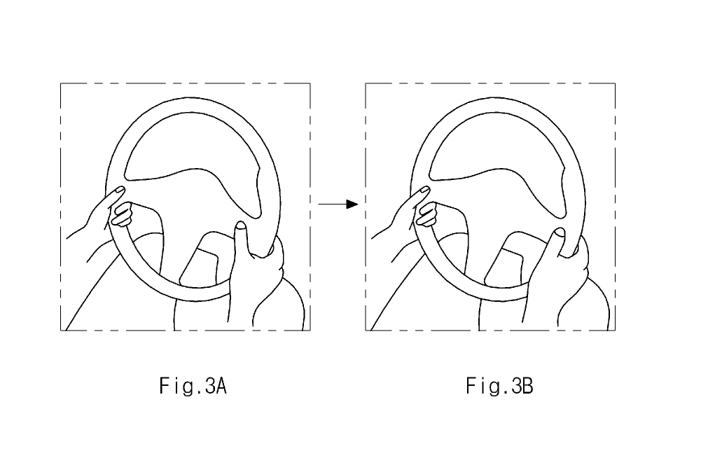

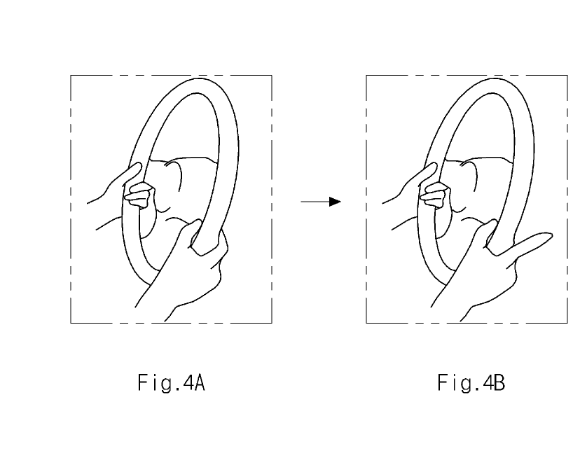

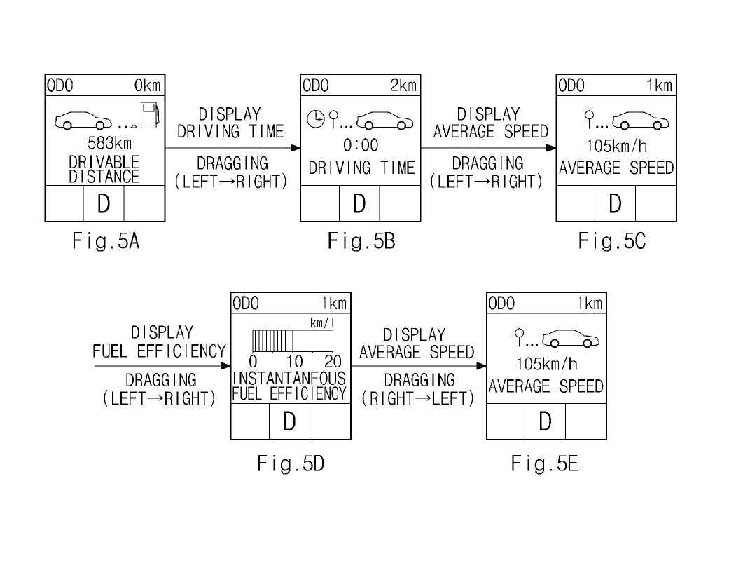

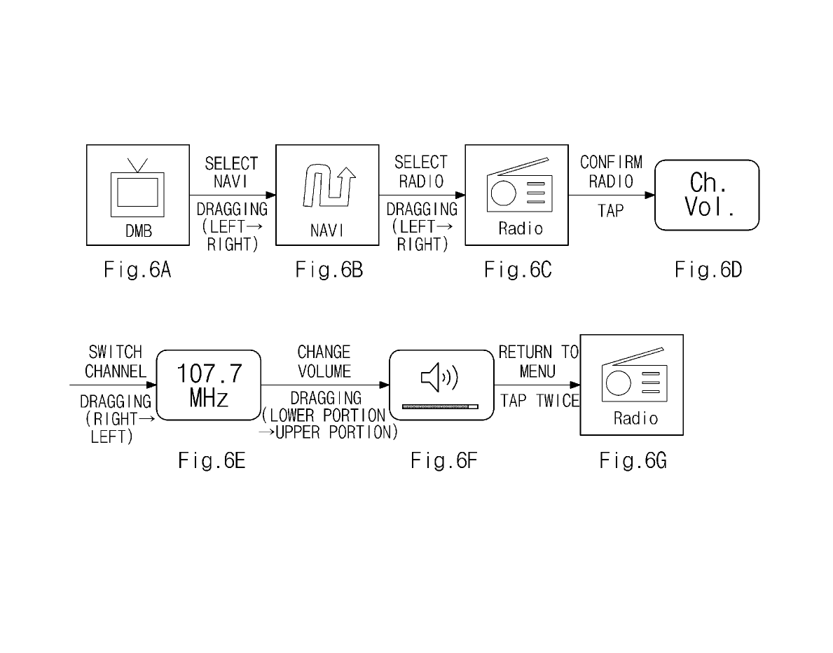

FIG. 1 is a block diagram showing the main components of a vehicle controlling apparatus installed on a steering wheel according to an exemplary embodiment of the present disclosure. FIG. 2 is a diagram showing a steering wheel mounted with an acoustic wave sensor according to an exemplary embodiment of the present disclosure. FIGS. 3A to 4B are diagrams showing a method of using a touch pad mounted on a steering wheel according to an exemplary embodiment of the present disclosure. FIGS. 5A to 6G are diagrams for describing a controlling method using a touch pad mounted on a steering wheel according to an exemplary embodiment of the present disclosure.

Referring to FIGS. 1 to 6G, a vehicle controlling apparatus 100 (hereinafter, referred to as a controlling apparatus) installed on a steering wheel according to an exemplary embodiment of the present disclosure includes an acoustic wave sensor 110, an output 130, a storage 150, and a controller 170.

The acoustic wave sensor 110 may be a microphone provided on the steering wheel 10. The acoustic wave sensor 110 converts an acoustic wave signal generated when a finger movement is present on the acoustic wave sensor 110 into an electrical signal and provides the converted electrical signal to the controller 170. The acoustic wave sensor 110 confirms whether an input signal input by a driver is a dragging signal or a tapping signal and converts the confirmed signal into the electrical signal. In addition, although the case in which the acoustic wave sensor 110 converts an acoustic wave signal into the electrical signal has been described in the exemplary embodiment of the present disclosure for convenience of explanation, the present disclosure is not necessarily limited thereto. The controlling apparatus may further include an acoustic wave pad (not shown) converting the acoustic wave signal obtained by the acoustic wave sensor 110 into the electrical signal.

More specifically, the dragging signal is mainly used to select menus such as cluster information of the vehicle, and control an AVN (Audio, Video, and Navigation) screen, vehicle internal lighting, a wiper, cooling and heating, a sunroof, an audio device, an air conditioner, various convenience devices, and the like. The tapping signal activates the menu selected by the dragging signal.

A method of inputting the dragging signal and the tapping signal is shown in FIGS. 3A to 4B. The driver may select various menus by horizontally and vertically dragging his/her finger on the acoustic wave sensor 110 disposed on a front surface of the steering wheel 10 and may activate the selected menu by tapping the acoustic wave sensor 110 disposed on a rear surface of the steering wheel 10 using his/her finger. Although the acoustic wave sensors 110 are disposed on the front and rear surfaces of the steering wheel 10 as described above according to an exemplary embodiment of the present disclosure for convenience of explanation, it may be appreciated by those skilled in the art that the acoustic wave sensor 110 may be disposed only on the front or rear surface of the steering wheel 10.

The output 130 displays screens such as the cluster information of the vehicle and the control of the AVN screen, the vehicle internal lighting, the wiper, cooling and heating, the sunroof, the audio device, the air conditioner, various convenience devices, and the like, under control of the controller 170.

The storage 150 stores information on several patterns corresponding to the dragging signal such as a method of dragging the finger on the acoustic wave sensor 110, a direction of dragging the finger, and the like, and information on the several patterns corresponding to the tapping signal such as the number of taps, an interval between the taps, and the like.

The controller 170 analyzes the electrical signal received from the acoustic wave sensor 110 to recognize a pattern depending on the input of the driver and performs an operation depending on the recognized pattern.

More specifically, an acoustic wave signal, that is an input signal generated when the driver moves his/her finger on the acoustic wave sensor 110, is converted into an electrical signal and then sent to the controller 170. For example, when the driver selects any one of the modes such as the cluster information of the vehicle, and the control of the AVN screen, the vehicle internal lighting, the wiper, cooling and heating, the sunroof, the audio device, the air conditioner, various convenience devices, and the like, the controller 170 controls the selected mode.

As shown in FIGS. 5A to 5E, when the driver drags his/her finger on the acoustic wave sensor 110 disposed on the front surface of the steering wheel 10 in order to confirm the cluster information of the vehicle, the controller 170 displays an amount of fuel and a drivable distance on the output 130 as shown in FIG. 5A. When the driver drags his/her finger from the left to the right on the acoustic wave sensor 110, the controller 170 displays a driving time of the vehicle on the output as shown in FIG. 5B. When the driver drags his/her finger from the left to the right on the acoustic wave sensor 110, the controller 170 displays an average speed of the vehicle on the output 150, as shown in FIG. 5C, and when the driver drags his/her finger from the left to the right on the acoustic wave sensor 110, the controller 170 displays an instantaneous fuel efficiency of the vehicle on the output 130, as shown in FIG. 5D. Further, when the driver drags his/her finger from the right to the left on the acoustic wave sensor 110, the controller 170 reverts the displayed screen to the previously viewed screen 5C, as shown in FIG. 5E.

In addition, the controller 170 may select menus and activate the selected menus. When the driver drags his/her finger on the acoustic wave sensor 110 disposed on the front surface of the steering wheel 10 in order to enter an AVN screen control mode, the controller 170 displays an AVN initial screen on the output 130 as shown in FIG. 6A, and when the driver drags his/her finger on the acoustic wave sensor 110, the controller 170 controls the output 130 to sequentially display AVN menus as shown in FIGS. 6B and 6C. When the driver taps the acoustic wave sensor 110 disposed on the rear surface of the steering wheel 10 once in order to select a radio of FIG. 6C, the controller 170 activates a radio control mode to display a screen for selecting a radio channel as shown in FIG. 6D. Then, when the driver drags his/her finger from the right to the left or from the left to the right on the acoustic wave sensor 110 disposed on the front surface of the steering wheel 10, the controller 170 displays a channel selected depending on the driver's selection on the output 130 as shown in FIG. 6E. When the driver drags his/her finger from a lower portion to an upper portion on the acoustic wave sensor 110 disposed on the front surface of the steering wheel 10, the controller 170 adjusts a volume of the radio depending on the driver's selection and displays a screen as shown in FIG. 6F on the output 130.

When the driver taps the acoustic wave sensor 110 provided on the steering wheel 10 after completing the adjustment of the channel and the volume of the radio, the controller 170 returns to the radio control mode to display a screen as shown in FIG. 6G on the output 130.

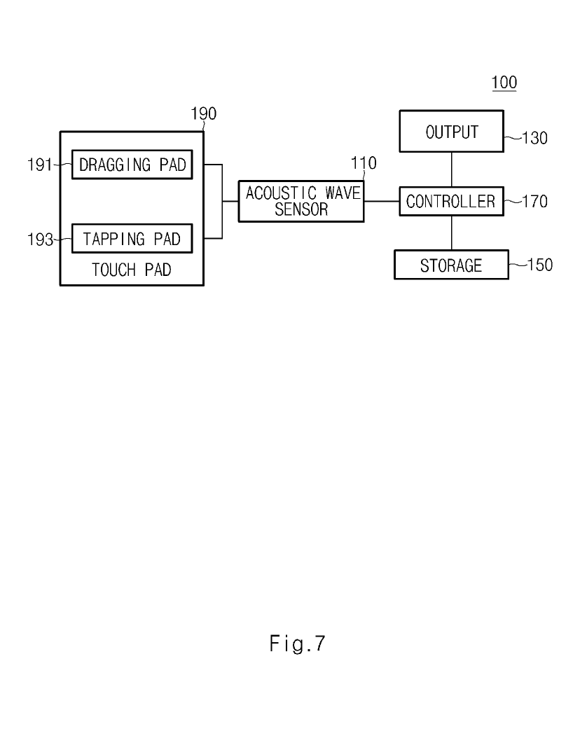

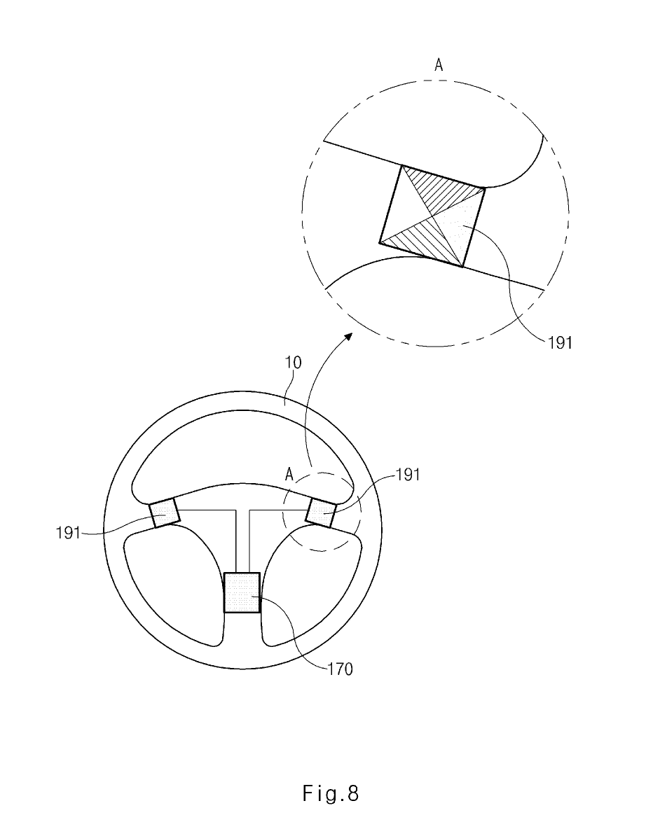

FIG. 7 is a block diagram showing the main components of a vehicle controlling apparatus installed on a steering wheel according to a second exemplary embodiment of the present disclosure. FIG. 8 is a diagram showing the steering wheel having a touch pad according to another exemplary embodiment of the present disclosure.

Referring to FIGS. 7 and 8, the vehicle controlling apparatus 100 (hereinafter, referred to as a controlling apparatus) installed on a steering wheel according to another exemplary embodiment of the present disclosure includes an acoustic wave sensor 110, an output 130, a storage 150, a controller 170, and a touch pad 190.

The touch pad 190 includes a dragging pad 191 mounted on a front surface of the steering wheel 10 as shown in FIG. 7 and a tapping pad 193 mounted on a rear surface of steering wheel 10 (not shown).

The dragging pad 191 may be disposed at a position at which a driver can reach by his/her thumb on the front surface of the steering wheel 10, and the tapping pad 193 may be disposed at a position which can be reached by the driver's forefinger on the rear surface of the steering wheel 10.

The dragging pad 191 is mainly used to select menus such as cluster information of the vehicle and control an AVN screen, vehicle internal lighting, a wiper, cooling and heating, a sunroof, an audio device, an air conditioner, various convenience devices, and the like. The tapping pad 193 is mainly used to activate the menu selected by an input of the dragging pad 191.

The dragging pad 191 may include four dragging pads 191 having different surface forms and materials as shown in A of FIG. 8, such that a recognition rate of the dragging pad 191 by the driver may be improved. A method of using the dragging pad 191 and the tapping pad 193 is shown in FIGS. 3A to 4B. The driver may select various menus by horizontally and vertically dragging his/her finger on the dragging pad 191 and activate the selected menu by tapping on the tapping pad 193.

Here, the acoustic wave sensor 110 means a microphone connected to the dragging pad 191 and the tapping pad 193. The acoustic wave sensor 10 converts an acoustic wave signal for vibrations generated by the movement of a finger on the dragging pad 191 and the tapping pad 193 into an electrical signal and transmits the converted electrical signal to the controller 170.

Since the output 130 has been described with reference to FIGS. 1 to 6G, a detailed description thereof will be omitted.

The storage 150 stores information on several patterns such as a method of dragging the finger on the dragging pad 191, a direction of dragging the finger, and the like, and information on several patterns such as the number of taps on the tapping pad 193, an interval between the taps, and the like.

The controller 170 analyzes the electrical signal received from the acoustic wave sensor 110 to recognize a pattern depending on the input of the driver and performs an operation depending on the recognized pattern. When the driver operates the touch pad 190, the acoustic wave signal depending on the vibrations generated in the touch pad 190 is converted into the electric signal and is then transmitted to the controller 170. Since the controller 170 is the same as the controller 170 described above with reference to FIGS. 1 to 6G, a detailed description thereof will be omitted.

As set forth above, according to the exemplary embodiment of the present disclosure, the acoustic wave sensor or the touch pad is provided on the steering wheel of the vehicle, such that the vehicle controlling apparatus installed on the steering wheel may be easily operated by the driver, and various apparatuses may be controlled in a state in which the driver keeps his hands on the steering wheel without distracting the driver's line of sight at the time of driving the vehicle, thereby preventing an accident.

According to the exemplary embodiment of the present disclosure, the acoustic wave sensor or the touch pad is provided on the steering wheel of the vehicle to minimize a size limitation of the steering wheel at the time of manufacturing the steering wheel as compared with buttons or switch schemes according to the related art, thereby making it possible to improve a degree of freedom in manufacturing the steering wheel.

Further, according to the exemplary embodiment of the present disclosure, the acoustic wave sensor or the touch pad is provided on the steering wheel of the vehicle to minimize a mechanical operation as compared with buttons or switch schemes according to the related art, thereby improving abrasion resistance and durability of the vehicle controlling apparatus installed on a steering wheel.

Hereinabove, the vehicle controlling apparatus installed on a steering wheel according to the exemplary embodiment of the present disclosure has been described. Although the exemplary embodiments of the present disclosure have been illustrated in the present specification and the accompanying drawings and specific terms have been used, they are used in a general meaning in order to assist in the understanding the present disclosure and do not limit the scope of the present disclosure. It will be obvious to those skilled in the art to which the present disclosure pertains that other modifications based on the spirit of the present disclosure may be made in addition to the above-mentioned exemplary embodiments.

What is claimed is:

1. A vehicle controlling apparatus installed on a steering wheel comprising:
an acoustic wave sensor disposed on the steering wheel of a vehicle, the sensor converting an acoustic wave signal generated by an input from outside the sensor into an electrical signal; and
a controller configured to analyze the electrical signal received from the acoustic wave sensor to recognize a pattern depending on the input from the outside and perform an operation depending on the recognized pattern.

2. The vehicle controlling apparatus installed on a steering wheel according to claim 1, wherein the acoustic wave sensor is mounted on any one of front and rear surfaces of the steering wheel.

3. The vehicle controlling apparatus installed on a steering wheel according to claim 2, wherein the controller recognizes the pattern from the electrical signal converted from a dragging signal, which is an acoustic wave signal generated by a horizontal or vertical input, and a tapping signal, which is an acoustic wave signal generated by tapping.

4. The vehicle controlling apparatus installed on a steering wheel according to claim 1, further comprising a touch pad connected to the acoustic wave sensor to generate a vibration signal by the input from the outside.

5. The vehicle controlling apparatus installed on a steering wheel according to claim 4, wherein the touch pad mounted on a front surface of the steering wheel includes at least two touch pads having different tactile feelings.

6. The vehicle controlling apparatus installed on a steering wheel according to claim 4, wherein the touch pad includes a dragging pad mounted on a front surface of the steering wheel and a tapping pad is mounted on a rear surface of the steering wheel.

7. The vehicle controlling apparatus installed on a steering wheel according to claim 6, wherein the controller recognizes the pattern from a horizontal or vertical drag signal input to the dragging pad and a tapping signal input to the tapping pad.

8. The vehicle controlling apparatus installed on a steering wheel according to claim 1, wherein the controller controls cluster information of the vehicle, an AVN (Audio, Video, and Navigation) screen, vehicle internal lighting, a wiper, cooling and heating, a sunroof, an audio device, an air conditioner, and various convenience devices based on the recognized pattern.
